(19) United States
(12) Patent Application Publication
(10) Pub. No.: US 2005/0225987 A1
(43) Pub. Date: Oct. 13, 2005

(54) Light-collimating system

(75) Inventors: Johannes Marra, Eindhoven (NL); Harald Glaeser, Freiburg (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/518,832

(22) PCT Filed: Jun. 13, 2003
(86) PCT No.: PCT/IB03/02953

§ 371 Date: Dec. 21, 2004

(30) Foreign Application Priority Data
Jun. 28, 2002 (EP) 02077562.3

(51) Int. Cl. F21V 1/00

(52) U.S. Cl. 362/328; 362/330

(57) ABSTRACT

A light-collimating system for collimating light from a light source has a plurality of elements (2, 2′, . . . 12, 12′, . . . ). Each element includes a first wall (3, 3′, . . . ; 13, 13′, . . . ) and a second wall (4, 4′, . . . ; 14, 14′, . . . ). The first wall and the second wall of each element are spaced with respect to each other. The first wall (3; 13) of an element (2; 12) and the second wall (4′; 14′) of an adjacent element (2′; 12′) form a wedge-shaped structure widening in a direction facing away from the light source. The first and second wall are at a side facing the wedge-shaped structure provided with a specular reflecting surface. Preferably, the space formed between the first and second wall of each element and the supporting member is provided with a specular and/or diffuse reflecting material.

The invention relates to a light-collimating system for collimating light.

Such light-collimating systems are known per se. They are used inter alia as backlight-collimating systems in (picture) display devices, for example for TV sets and monitors. Such light-collimating systems are particularly suitable for use as backlights for non-emissive displays such as liquid crystal display devices, also denoted LCD panels, which are used in (portable) computers, TV sets or (portable) telephones.

Said display devices usually comprise a substrate provided with a regular pattern of pixels which are each controlled by at least one electrode. The display device utilizes a control circuit for achieving a picture or a data graphical display in a relevant field of a (picture) screen of the (picture) display device. The light originating from the backlight in an LCD device is modulated by means of a switch or modulator, various types of liquid crystal effects being used. In addition, the display may be based on electrophoretic or electromechanical effects.

Such light-collimating systems are also used as luminaires for general lighting purposes or for shop lighting, for example shop window lighting or lighting of (transparent or semi-transparent) plates of glass or of synthetic resin on which items, for example jewelry, are displayed. Such light-collimating systems are further used as window panes, for example for causing a glass wall to radiate light under certain conditions, or to reduce or block out the view through the window by means of light. Further alternative applications are the use of such light-collimating systems for illuminating advertising boards, drawing tables and X-Ray photographs.

In the light-collimating systems mentioned in the opening paragraph, the light source used is usually a tubular low-pressure mercury vapor discharge lamp, for example one or a plurality of cold-cathode fluorescent lamps (CCFL), wherein the light emitted by the light source during operation is coupled into the light-emitting panel, which acts as an optical waveguide. This waveguide usually constitutes a comparatively thin and planar panel which is manufactured, for example, from synthetic resin or glass, and in which light is transported through the optical waveguide under the influence of (total) internal reflection.

As an alternative light source, such a light-collimating system may also be provided with a plurality of optoelectronic elements, also referred to as electro-optical elements, for example electroluminescent elements, for example light-emitting diodes (LEDs). These light sources are usually provided in the vicinity of or tangent to a light-transmitting edge surface of the light-emitting panel, in which case light originating from the light source is incident on the light-transmitting edge surface during operation and distributes itself in the panel.

Light-collimating systems are preferably embodied as direct-lit backlight-collimating systems when high emitted light intensities are desired and/or when large-area light-emitting surfaces have to be provided. Such a direct-lit backlight-collimating system is known from WO-A 97/36 131. The known backlight-collimating system comprises at least one light source, and a light-directing assembly in close proximity to the light source, the light-directing assembly comprising so-called micro-prisms and blocking means between the micro prisms, the blocking means locally blocking the passage of light. In the known light-collimating system the light-blocking means are reflective elements while a reflector is positioned behind and/or around the light source, that is, in the direction away from the light-directing assembly, to redirect light rays propagating away from the light-directing assembly back towards the micro prisms. Employing specular and diffusely reflecting materials, this preferred embodiment increases the total available light output and efficiency of the backlight-collimation system. A drawback of the known light-collimating system is that the total available light output and efficiency of the light-collimating system is still relatively poor.

It is an object of the invention to eliminate the above disadvantage wholly or partly. To meet the object of the invention, the light-collimating system includes:
a plurality of elements, each element including a first wall and a second wall,
the first wall and the second wall of each element being spaced with respect to each other,
the first wall of an element and the second wall of an adjacent element forming a wedge-shaped structure widening in a direction facing away from the light source,
the first wall and the second wall at a side facing the wedge-shaped structure being provided with a specular reflecting surface.

In the light-collimating system according to the invention, light collimation results from specular reflections from the walls of the wedge-shaped structures. In the known light-collimating system collimation of light is brought about by the total internal reflection (TIR) of incident light from the optically smooth walls of the micro prisms.

In the light-collimating system according to the invention, the wedge-shaped structures are open, hollow structures (filled with air, refractive index n=1). Depending on the design of the wedge-shaped structures, successive reflections may occur in the wedge-shaped structure, which is advantageous for obtaining a large aperture of the light-collimating system. Preferably, the first and second walls are made from a sheet material. Such sheets can easily be drawn into the desired shape, for instance, by a thermal deep-drawing process. In the known light-collimating systems, the wedge-shaped micro prism structures are made from a solid transparent material. The micro prisms in the known light-collimating system have a refractive index which corresponds to the refractive index of the material from which the prisms have been made (generally the refractive index is n≈1.5).

In the description of this invention, the hollow wedge-shaped structure is also addressed as a (hollow) wedge collimator.

A preferred embodiment of the light-collimating system according to the invention is characterized in that the first wall and the second wall are straight walls. Such a so-called cone-shaped open wedge is relatively easy to manufacture.

An alternatively preferred embodiment of the light-collimating system according to the invention is characterized in that the first wall and the second wall are curved, preferably parabolically-shaped walls. A curved or parabolically-shaped wedge is more difficult to manufacture, but is optically more efficient since it allows a certain degree of light collimation to be attained at a larger aperture at no more than only a single specular reflection from the parabolically-shaped walls.

A preferred embodiment of the light-collimating system according to the invention is characterized in that the first wall and the second wall of each element are provided on a supporting member at a side facing away from the light source, and that the supporting member between the first wall and the second wall of each element is provided with a light-reflecting element comprising a specular and/or diffuse reflecting material. Light produced inside the backlight-collimating system is allowed to escape herefrom only through the aperture-window between the first wall of an element and a second wall of an adjacent element, i.e. at the location of the wedge-shaped structures. Between the first and second wall of an element light is not allowed to become transmitted. By providing a reflective element between the first and second wall of an element, light is effectively and efficiently back-reflected and subsequently recycled in the backlight-collimating system.

A preferred embodiment of the light-collimating system according to the invention is characterized in that a space formed between the first wall and the second wall of each element is provided with a specular and/or diffusely reflecting material. If a supporting member is provided in the light-collimating system, the specular and/or diffusely reflecting material is provided in the space formed between three walls, i.e. the first and second wall of each element and the supporting member. Such materials largely shield the specular reflecting surface of the first and second wall from direct exposure to light emitted from the light source inside the light-collimating system, thus counteracting loss of light through light absorption by the specular reflecting surfaces. Preferably, the material is diffusely reflecting.

Reflective layers and/or coatings are usually present in any application involving efficient light recycling, light (re)distribution, light transport, and light collimation. Imposed demands on the reflective materials comprise the absence of light absorption within the visible wavelength region, the absence of absorption-induced colour shifts, a high resistance to chemical degradation under the (combined) influence of heat, light, humidity, and an availability at low cost while being easy to process/manufacture. Suitably performing reflective layers are layers of dry binder-free inorganic powder particles. Preferably, the reflecting material is selected from the group formed by aluminum oxide, barium sulfate, calcium-pyrophosphate, titanium oxide and yttrium borate. Such powders very efficiently contribute to light recycling in (back) light-collimating systems. Preferably, the reflecting powder is mixed with particles of Alon-C powder (a gamma-structure aluminium oxide powder (Degussa) possessing an average primary particle size of approximately 20 nm). When calcium-pyrophosphate powder, possessing an average particle diameter of at least 5 μm, is mixed with 1% w/w Alon-C powder, the resulting powder mixture behaves like a so-called free-flowing powder.

A preferred embodiment of the light-collimating system according to the invention is characterized in that the first wall and the second wall are made from glass, metal or plastic. Preferably, the open wedge structure can be created by e.g. a thermal deep-drawing process of an optically smooth aluminum sheet or a plastic PET sheet that is subsequently coated with an aluminum or silver layer. The aluminum sheet or layer functions as the specular reflecting surface. The aperture windows, i.e. the space, at the location of the supporting member, between the first wall of an element and a second wall of an adjacent element can be left entirely open.

A preferred embodiment of the light-collimating system according to the invention is characterized in that, at the location of the supporting member, the distance dₛₚ between the first wall and the second wall of each element is larger than the wavelength of visible light. By selecting the distance dₛₚ substantially larger than approximately 500 nm, preferably dₛₚ≧10 μm, light diffraction phenomena in and around the wedge structures are avoided enabling that a diffraction-induced disturbance of the collimation performance of the wedge collimator structure does not occur. Preferably, the distance dₛₚ≧1 mm. The spaces between the first and second wall of an element can then be readily provided with free-flowing Ca-pyrophosphate powder (mixed with 1% w/w Alon-C).

A preferred embodiment of the light-collimating system according to the invention is characterized in that the height h_{w} of the wedge-shaped structures is in the range 0.5×d_{aw}≦h_{w}≦50×d_{aw}, where d_{aw} is the distance between the first wall and the second wall at the location of the first and second wall facing the light source. If a supporting member is provided in the light-collimating system, d_{aw} is the distance between the first wall and the second wall at the location of the supporting member. With a height h_{w} in the given range isotropic light emitted by the light source inside the light-collimating system can be collimated to a collimation angle θ_{c} within the range 10°≦θ_{c}≦90°.

A preferred embodiment of the light-collimating system according to the invention is characterized in that the light-collimating system further comprises a lens assembly, comprising a plurality of lenses, each lens cooperating with one of the wedge-shaped structures. The obtained degree of collimation is further enhanced through the presence of an optional lens assembly on the light-emitting side of the wedge collimator.

A particularly simple light-collimating system is obtained through the measures according to the invention. In particular, the total available light output and efficiency of the light-collimating system is rather high.

The invention will now be explained in more detail with reference to a number of embodiments and a drawing, in which:

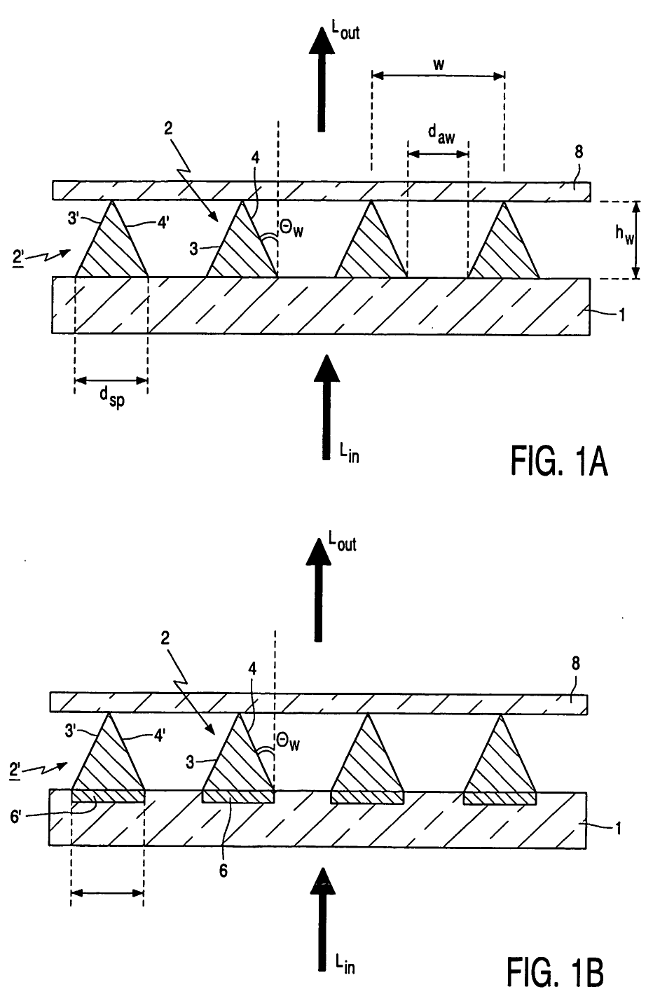

FIG. 1A is a cross-sectional view of an embodiment of the wedge collimator according to the invention;

FIG. 1B is a cross-sectional view of an alternative embodiment of the wedge collimator according to the invention;

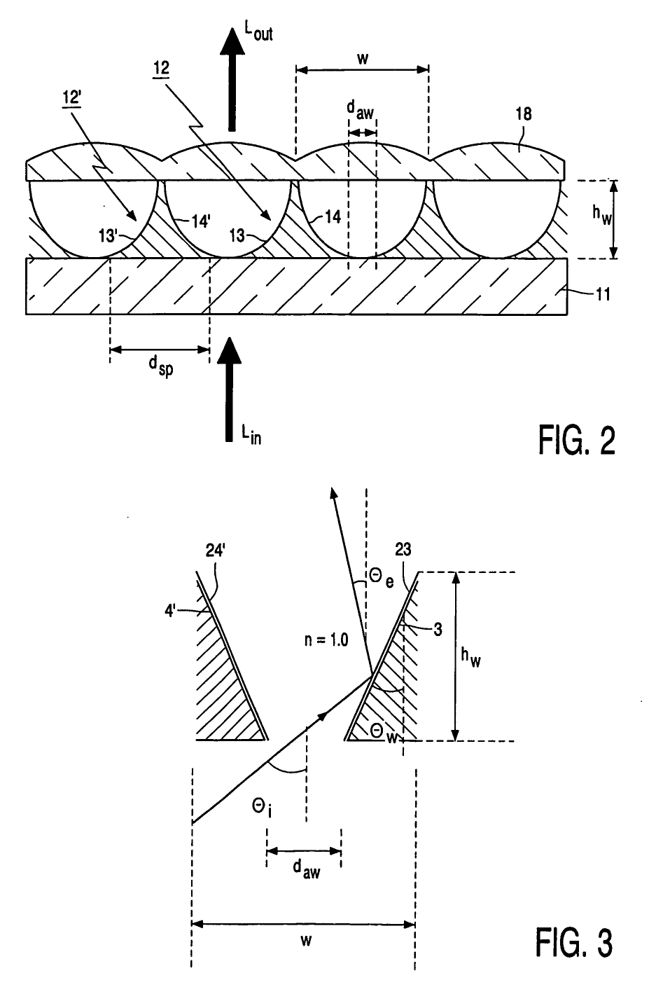

FIG. 2 is a cross-sectional view of a further alternative embodiment of the wedge collimator according to the invention;

FIG. 3 shows a path of a light ray through a detail of the wedge collimator of FIG. 1A or 1B;

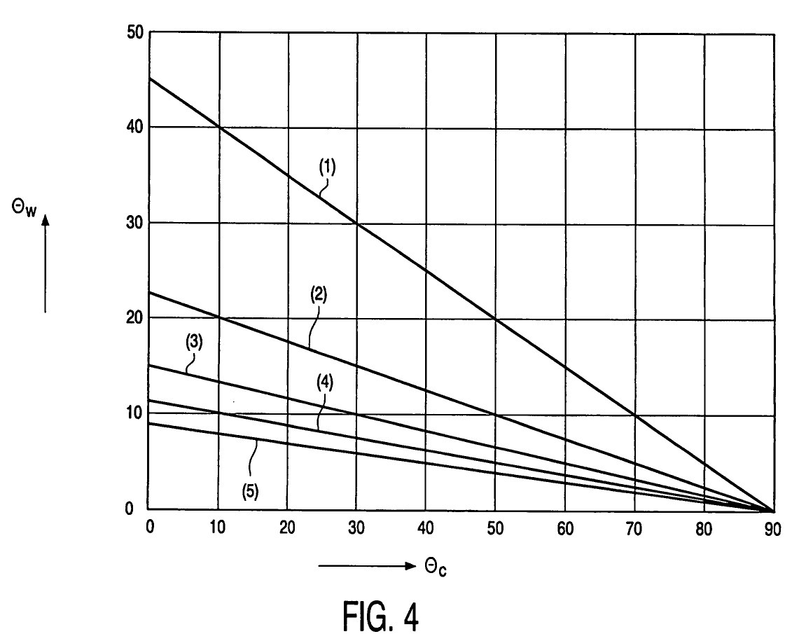

FIG. 4 shows the wedge angle θ_{w} as a function of the collimation angle θ_{c} for the wedge collimator of FIG. 1A or 1B, and

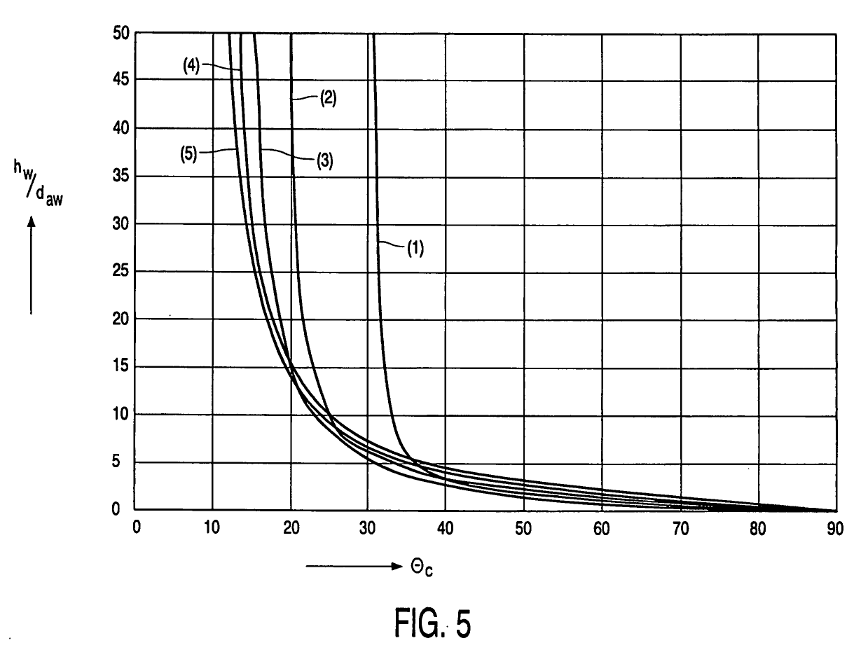

FIG. 5 shows the ratio h_{w}/d_{aw} as a function of the collimation angle θ_{c} for the wedge collimator of FIG. 1A or 1B.

The Figures are purely diagrammatic and not drawn true to scale. Some dimensions are particularly strongly exaggerated for reasons of clarity. Equivalent components have been given the same reference numerals as much as possible in the Figures.

FIG. 1A schematically shows a cross-sectional view of an embodiment of the wedge collimator according to the invention. FIG. 1B schematically shows an alternative embodiment of the wedge collimator. The light-collimating system of FIGS. 1A and 1B comprises a supporting member 1 for admitting light from a light source (not shown in FIGS. 1A and 1B; the direction of the incident light is indicated by the arrow Lᵢₙ) into the light-collimating system. The supporting member 1 is provided at a side facing away from the light source with a plurality of elements 2, 2′, . . . . Each element 2, 2′, . . . consists of a first wall 3, 3′, . . . and a second wall 4, 4′, . . . . Preferably, the first wall 3, 3′, . . . and the second wall 4, 4′, . . . are made from glass, metal or plastic. The first wall 3 and the second wall 4′ of each element 2, 2′, . . . are spaced with respect to each other at the location of the supporting member 1. The distance between the first wall 3 and the second wall 4′ at the location of the optional supporting member is the so-called aperture width d_{aw}. The first wall 3 of an element 2 and the second wall 4′ of an adjacent element 2′ form a wedge-shaped structure widening in a direction facing away from the light source for collimating light from the light source. The first wall 3, 3′, . . . and the second wall 4, 4′, . . . at a side facing the wedge-shaped structure being provided with a specular reflecting surface (not shown in FIGS. 1A and 1B, but see in FIG. 3). In the example of FIGS. 1A and 1B, the wedge-shaped structures are covered by a covering plate 8. In an alternative embodiment the covering plate is formed as a lens assembly comprising a plurality of lenses (see FIG. 2). In the example of FIGS. 1A and 1B, the first wall 3, 3′, . . . and the second wall 4, 4′, . . . are straight walls. The supporting member is an optional feature of the light-collimating system. In particular when the first and second walls are made from a sheet material, such sheets can easily be drawn into the desired shape and no supporting member is necessary to provide sufficient support for the first and second wall of the light-collimating system.

In FIG. 1A, the space formed between the first wall 3, 3′, . . . and the second wall 4, 4′, . . . of each element 2, 2′, . . . and the supporting member 1 is provided with a specular and/or diffusely reflecting material.

In FIG. 1B, the supporting member 1 between the first wall 3, 3′, . . . and the second wall 4, 4′, . . . of each element 2, 2′, . . . is provided with a light-reflecting element 6; 6′ comprising a specular and/or diffuse reflecting materials.

The specular or diffuse reflecting material of the light-reflecting element 6; 6′ preferably comprises a powder material, the material selected from the group formed by aluminum oxide, barium sulfate, calcium-pyrophosphate, titanium oxide and yttrium borate. Use of Ca-pyrophosphate with an average particle diameter between 8 and 10 μm is particularly recommended because of its ready availability, cheapness, chemical purity, resistance to high temperatures (>1000° C.), and its proven non-absorbing characteristics towards visible light within the λ=400-800 nm range after annealing at 900° C. in air. When Ca-pyrophosphate is mixed with 1% w/w Alon-C nano-particles, the resulting powder mixture behaves like a so-called free-flowing powder.

At the location of the supporting member 1, the distance dₛₚ between the first wall 3, 3′, . . . and the second wall 4, 4′, . . . of each element 2, 2′, . . . is preferably larger than the wavelength of visible light. Preferably, both the distances dₛₚ and d_{aw} are larger than 10 μm. Preferably, the distance dₛₚ is larger than 1 mm. The latter makes the filling of the spaces between the first wall 3, 3′, . . . and the second wall 4, 4′, . . . with the particles of dry, binder-free free-flowing inorganic powder relatively simple. Preferably, the height h_{w} of the wedge-shaped structures is in the range 0.5×d_{aw}≦h_{w}≦50×d_{aw}, where d_{aw} is the distance between the first wall 3, 3′, . . . and the second wall 4, 4′, . . . at the location of the supporting member 1. According to the invention, the light issuing from the light-collimating system (indicated by the arrow Lₒᵤₜ in FIGS. 1A and 1B) is collimated.

FIG. 2 schematically shows a cross-sectional view of a further embodiment of the wedge collimator according to the invention. The light-collimating system of FIG. 2 comprises a supporting member 11 for admitting light from a light source (not shown in FIG. 2; the direction of the incident light is indicated by the arrow Lᵢₙ) into the light-collimating system. The supporting member 11 is provided at a side facing away from the light source with a plurality of elements 12, 12′, . . . . Each element 12, 12′, . . . consists of a first wall 13, 13′, . . . and a second wall 14, 14′, . . . . Preferably, the first wall 13, 13′, . . . and the second wall 14, 14′, . . . are made from glass, metal or plastic. The first wall 13 and the second wall 14′ of each element 12, 12′, . . . are spaced with respect to each other at the location of the supporting member 11. The distance between the first wall 13′ and the second wall 14 is the so-called aperture width. The first wall 13 of an element 12 and the second wall 14′ of an adjacent element 12′ form a wedge-shaped structure widening in a direction facing away from the light source for collimating light from the light source. The first wall 13, 13′, . . . and the second wall 14, 14′, . . . at a side facing the wedge-shaped structure being provided with a specular reflecting surface. In the example of FIG. 2, the wedge-shaped structures are covered by a covering plate formed as a lens assembly 18, comprising a plurality of lenses, each lens cooperating with one of the wedge-shaped structures. In the example of FIG. 2, the first wall 13, 13′, . . . and the second wall 14, 14′, . . . are parabolically-shaped walls.

In FIG. 2, the space formed between the first wall 13, 13′, . . . and the second wall 14, 14′, . . . of each element 12, 12′, . . . and the supporting member 11 is provided with a diffusely reflecting material. The diffusely reflecting material is preferably selected from the group formed by aluminum oxide, barium sulfate, calcium-pyrophosphate, titanium oxide and yttrium borate.

FIG. 3 shows schematically a path of a light ray through a detail of the wedge collimator of FIG. 1A or 1B (the supporting member and the covering plate are not shown). A first wall 3 and a second wall of an adjacent element are shown. The first wall 3 is provided with a specular reflecting surface 23 and the second wall 4′ is provided with a specular reflecting surface 24′. In the example of FIG. 3 a light ray is incident on the open wedge (refractive index n=1) at an angle θᵢ (with respect to the normal, parallel to Lᵢₙ in FIG. 1A) and is reflected at the specular reflecting surface 23 on the first wall 3 that makes an angle θ_{w} (wedge angle) with the normal. In the example of FIG. 3 only one reflection takes place and the light ray issuing from the wedge collimator makes an angle θ_{c} with respect to the normal. The number of reflections depends on the incident angle θᵢ, the height h_{w} of the elements, and the wedge angle θ_{w}. The collimation angle θ_{c} with respect to the normal refers to the largest angle θₑ at which a light ray can emerge from the wedge structure when isotropic light with 0°≦θᵢ≦90° with respect to the normal is incident upon the wedge-shaped structure. In other words θ_{c}=(θₑ)ₘₐₓ.

FIG. 4 shows the wedge angle θ_{w} as a function of the collimation angle θ_{c} for the wedge collimator of FIG. 1A or 1B. FIG. 5 shows the ratio h_{w}/d_{aw} as a function of the collimation angle θ_{c} for the wedge collimator of FIG. 1A or 1B. In FIGS. 4 and 5 curve (1) shows the results if a maximum of only 1 reflection occurs, curve (2) if a maximum of 2 reflections occurs, curve (3) if a maximum of 3 reflections occurs, curve (4) if a maximum of 4 reflections occurs and curve (5) if a maximum of 5 reflections occurs in the wedge-shaped structure. It can be seen that the aperture d_{aw} always decreases at increasing levels of collimation (i.e. a decreasing θ_{c}). For a given maximum number of specular reflections, a limit exists with respect to the maximum achievable degree of collimation. For example, if the maximum number of specular reflections is 1, the wedge-shaped structure with straight walls cannot collimate isotropic light to better than approximately 30°. At increasing maximum numbers of specular reflections, the maximum achievable degree of collimation increases as well. However, it is difficult to achieve θ_{c}<20°0 at an efficient lumen efficacy, also because of the very small apertures that then exist. As the number of reflections increases the lumen loss due to absorption losses in the reflecting metal surfaces also increases. To realize θ_{c}≦20° parabolic-shaped wedge-shaped structures are preferably employed (see FIG. 2). At a given degree of collimation, the aperture of the known wedge collimator is larger than that of the open wedge collimator, in particular at higher degrees of collimation. The hollow wedge collimator, designed to accommodate one specular reflection is a suitable choice for collimating isotropic light down to the θ_{c}=60° as normally required in an office environment. The two-dimensional aperture is then close to 50%. At a ratio h_{w}/d_{aw}=0.68 an hollow wedge structure with d_{aw}=4.4 mm, h_{w}=3.0 mm, and a collimator width w=6.0 mm accomplishes a collimation angle θ_{c}=60° when isotropic light is incident onto the hollow wedge structure. To warrant an easy filling of the wedge cavities with white reflective powder, these dimensions are very suitable. In view of the above, the general recommendation is to use an open wedge for θ_{c}÷40°. Smaller values of θ_{c} at not-too-small values of the aperture width d_{aw}/w are preferably accomplished with a parabolic-shaped wedge structure. When using a cone-shaped wedge-shaped structure, a comparatively larger aperture width ratio d_{aw}/w, a smaller θ_{w} and a smaller ratio h_{w}/d_{aw} can be accomplished in case an additional lens assembly positioned on top of the wedge structure.

The scope of protection of the invention is not limited to the embodiments given. The invention resides in each novel characteristic and each combination of characteristics. Reference numerals in the claims do not limit the scope of protection thereof. The use of the verb “comprise” and its declinations does not exclude the presence of elements other than those specified in the claims. The use of the indefinite article “a” or “an” preceding an element does not exclude the presence of a plurality of such elements.

1. A light-collimating system for collimating light from a light source,
a plurality of elements, each element including a first wall and a second wall,
the first wall and the second wall of each element being spaced with respect to each other,
the first wall of an element and the second wall of an adjacent element forming a wedge-shaped structure widening in a direction facing away from the light source,
the first wall and the second wall at a side facing the wedge-shaped structure being provided with a specular reflecting surface.

2. A light-collimating system as claimed in claim 1, characterized in that the first wall and the second wall are straight walls.

3. A light-collimating system as claimed in claim 1, characterized in that the first wall and the second wall are curved, preferably, parabolically-shaped walls.

4. A light-collimating system as claimed in claim 3, characterized in that the first wall and the second wall are parabolically-shaped walls.

5. A light-collimating system as claimed in claim 1, characterized in that the first wall and the second wall of each element are provided on a supporting member at a side facing away from the light source, and that the supporting member (1) between the first wall and the second wall of each element is provided with a light-reflecting element comprising a specular and/or diffuse reflecting material.

6. A light-collimating system as claimed in claim 1, characterized in that a space formed between the first wall and the second wall of each element is provided with a specular and/or diffuse reflecting material.

7. A light-collimating system as claimed in claim 6, characterized in that the reflecting material is selected from the group formed by aluminum oxide, barium sulfate, calcium-pyrophosphate, titanium oxide and yttrium borate.

8. A light-collimating system as claimed in claim 7, characterized in that the reflecting material is mixed with particles of Alon-C.

9. A light-collimating system as claimed in claim 1, characterized in that the first wall and the second wall are made from glass, metal or plastic.

10. A light-collimating system as claimed in claim 1, characterized in that, at the location of the first and second wall facing the light source, the distance dₛₚ between the first wall and the second wall of each element is larger than the wavelength of visible light.

11. A light-collimating system as claimed in claim 10, characterized in that the distance dₛₚ≧10 μm.

12. A light-collimating system as claimed in claim 11, characterized in that the distance dₛₚ≧1 mm.

13. A light-collimating system as claimed in claim 11, characterized in that the height h_{w} of the wedge-shaped structures is in the range 0.5×d_{aw}≦h_{w}≦50×d_{aw}, where d_{aw} is the distance between the first wall and the second wall at the location of the first and second wall facing the light source.

14. A light-collimating system as claimed in claim 1, characterized in that the light-collimating system further comprises a lens assembly, comprising a plurality of lenses, each lens cooperating with one of the wedge-shaped structures.
